(19) United States
(12) Patent Application Publication
(10) Pub. No.: US 2012/0203712 A1
(43) Pub. Date: Aug. 9, 2012

(54) METHOD AND APPARATUS FOR ISSUING MUNICIPAL BONDS REDEEMABLE FOR FUTURE PAYMENTS OF TAXES AND OTHER OBLIGATIONS TO ISSUING MUNICIPALITY

(76) Inventor: Paul FENNELL, Scottsdale, AZ (US)

(21) Appl. No.: 13/324,644

(22) Filed: Dec. 13, 2011

Related U.S. Application Data
(60) Provisional application No. 61/479,008, filed on Apr. 26, 2011.

(51) Int. Cl. G06Q 40/06

(52) U.S. Cl. 705/36 T

(57) ABSTRACT

A system and method of issuing municipal bonds (tax coupon bond, zero coupon bonds, etc.) includes issuing, from a bond agent computer, a bond offering for prospective bond holders, and purchasing, by at least one of the prospective bond holders using a prospective bond holders/investor device, at least one of the offered bonds, wherein the at least one purchased bond is redeemable to offset a bond owner's tax liability to a municipality authorizing the issuance of the bond at a future date.

### CROSS-REFERENCE TO RELATED APPLICATIONS

This patent application claims the benefit of co-pending U.S. Provisional Patent Application No. 61/479,008, filed on Apr. 26, 2011, the entire disclosure of which is hereby incorporated by reference herein in its entirety.

### FIELD

The present disclosure is directed to a method and apparatus for issuing municipal and other bonds, a method that provides credit enhancement of a debt issue through the mechanism of a tax offset, which allows a bondholder to receive tax credits in lieu of either interest or principal payments due him/her. This is not a tax strategy but, rather, a method of enabling municipalities (states, cities, and counties, for example) and other issuers to raise funds at a lower debt cost, because it provides high-quality credit enhancement without subjecting bondholders to traditional counterparty or credit risk. Because a bondholder can offset foregone debt payments with an equivalent reduction in his/her taxes, he/she is assured of receiving full value even under the extreme circumstance where the issuing entity is unable to make payments, all without relying on the ability or discretion of a third-party insurer to make alternate payment.

From the investor's viewpoint, this method substantially insulates a bondholder from the downside credit risk of owning such a debt issue. From the issuer's viewpoint this method provides a straightforward and efficient mechanic to lower its cost of capital, perhaps significantly.

### DESCRIPTION OF THE RELATED ART

Before the financial collapse of 2008, up to 50% of new-issue municipal bonds were insured by third-party providers, who guaranteed debt payments to bondholders in the event an issuer failed to pay. Debt issues insured by providers like, for example, FGIC and AMBAC, typically received the highest possible credit rating, “AAA,” because these providers were themselves rated “AAA.” Although an issuer would have to pay a premium for such an insurance policy, that policy could significantly reduce its net borrowing cost.

The 2008 financial collapse also reverberated through the municipal bond insurance market. Major providers lost their “AAA” ratings, and the remaining pool of insurers shrank as some providers exited the business altogether. Many of the financial assets held by these insurers—at one time considered “AAA” assets—did not survive the 2008 storm. Investors who paid for “AAA” AMBAC-insured bonds, for example, now found themselves owning essentially worthless insurance. At this writing only about 10% of new-issue municipal bonds are insured, and there is no “AAA” insurance provider active in the market. Additionally, investors have become extremely skeptical of complicated techniques for creating “AAA” securities—like those for multiple-tranche mortgage securities—because many of these structures exposed bondholders to significant losses.

What is needed is a mechanism that provides straightforward, high-quality credit enhancement without the risks associated with third-party insurers or complex structured products.

### SUMMARY

The present inventor has observed that while the credit quality of a municipality may vary according to a number of factors, the quality of a tax credit remains high regardless of the issuer's circumstances. For example, a credit that can be used against a city's property taxes will be valuable regardless whether the city is rated “AAA” or is in bankruptcy, because taxpayers must pay it under either scenario. Therefore, if a bondholder knew that he/she could receive tax credits in lieu of the debt payments owed to him/her, then he/she would be assured of receiving value on the bonds, even under the circumstance where the issuer was unable to make cash payments on the bonds. In effect, bonds that incorporated this tax offset mechanism would offer high-quality insurance, but without counterparty or credit risk.

Hence, the present method and apparatus for issuing municipal bonds (Tax Offset Municipal Securities or “TOMS”) offers investors a very low risk way to invest in municipal and other debt securities, even in the securities of issuers experiencing severe financial difficulties. It offers issuers an innovative and effective method to widen their access to the capital markets while also reducing their debt costs.

Part of the wider access to capital markets stems from the broad appeal of bonds that would incorporate this mechanism. Even investors who could not directly take advantage of a tax offset may still seek to buy these bonds. For example, a New York resident who had no California tax liability may still purchase TOMS bonds issued by a California municipality. The appeal would be a high-quality, low-risk bond that is easily traded in the secondary market.

It is an object of the present method and apparatus to provide high-quality credit enhancement of a debt issue without subjecting bondholders to traditional counterparty or credit risk, this accomplished through the vehicle of tax offsets, which may be offered by any municipality or other tax-imposing entity, not just the issuer. This method of credit enhancement can be used by municipal issuers, corporate issuers, in fact virtually any issuer so long as there is a tax-imposing entity willing to enter into a tax offset arrangement.

Other objects, aspects and advantages of the present method and apparatus can be obtained from a study of the specification, the drawings, and the appended claims.

### BRIEF DESCRIPTION OF THE DRAWING FIGURES

FIG. 1 illustrates an exemplary computer architecture for carrying out the disclosed exemplary municipal bond issuance method in the present disclosure.

FIG. 2 illustrates an exemplary computer architecture for a device for carrying out the disclosed exemplary municipal bond issuance method in the present disclosure.

FIG. 3 is a flow chart illustrating at a conceptual level the method steps employed by the present disclosure.

### DETAILED DESCRIPTION

### System Architecture

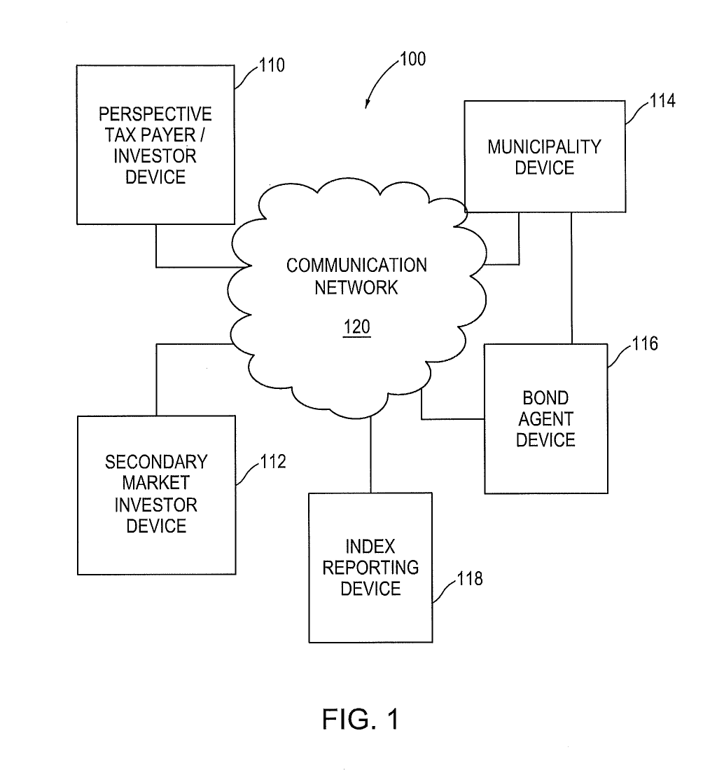

FIG. 1 illustrates an exemplary computer architecture, shown generally at 100, for carrying out the disclosed exemplary municipal bond issuance method. The architecture 100 includes a prospective taxpayer/investor device 110, a secondary market investor device 112, a municipality authority (or other taxing authority) device 114, a tender, or bond agent, device 116, and an index reporting device 118, all connected with each other through a communications network 120, such as, for example, the Internet.

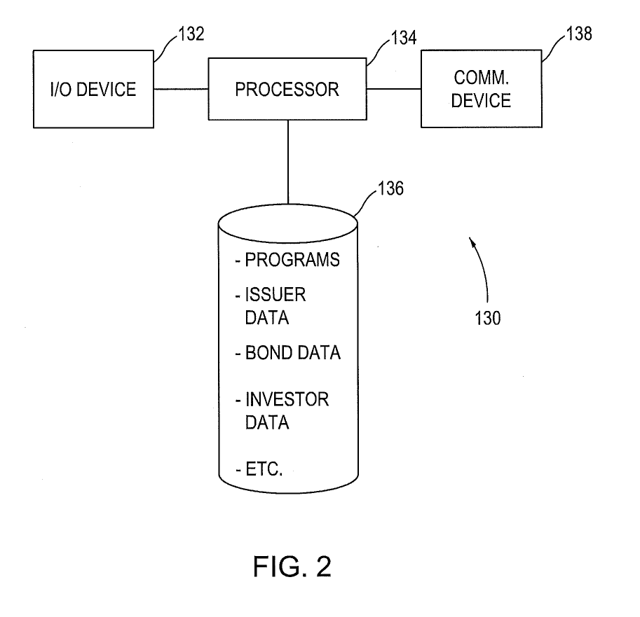

Each of the devices 110-118 may be a general purpose computer suitable for use in performing the functions described herein. FIG. 2 illustrates a general block diagram of a general purpose computer which may be utilized for each of the devices 110-118. As shown in FIG. 2, each computing device 130 includes an input/output device 132 for receiving data and instructions from, and communicating information and results to, a user, processor 134 (e.g., a CPU), a memory 136 (e.g., random access memory (RAM) and/or read only memory (ROM)), and a communications device 138 (e.g., receiver/transmitter) for communication with other devices via the communications network 120. Stored in the memory are the various programs run on the computing device 130, as well as other information relevant to the disclosed system and method, such as, bond issuer data, bond data, indexer data, etc. It should be understood that each device 110-118 will not initially include all of the relevant bond data but, as the transaction takes place, this information will be transferred between devices.

The municipality device 114 works with and transfers information regarding a bond issue to the bond agent device 116. A bond offering is made to prospective investors by the bond agent device. A prospective taxpayer/investor purchases the bond(s), via the prospective taxpayer/investor device 110, from the bond agent device 116. Interest or principal payments on the bonds will not be made to the extent an election is made to receive a tax offset instead. The purchased bonds may be exchanged with secondary market investors via the secondary market investor device 112. The issuance, exchange and sale of the bonds is monitoring by the index reporting device 118.

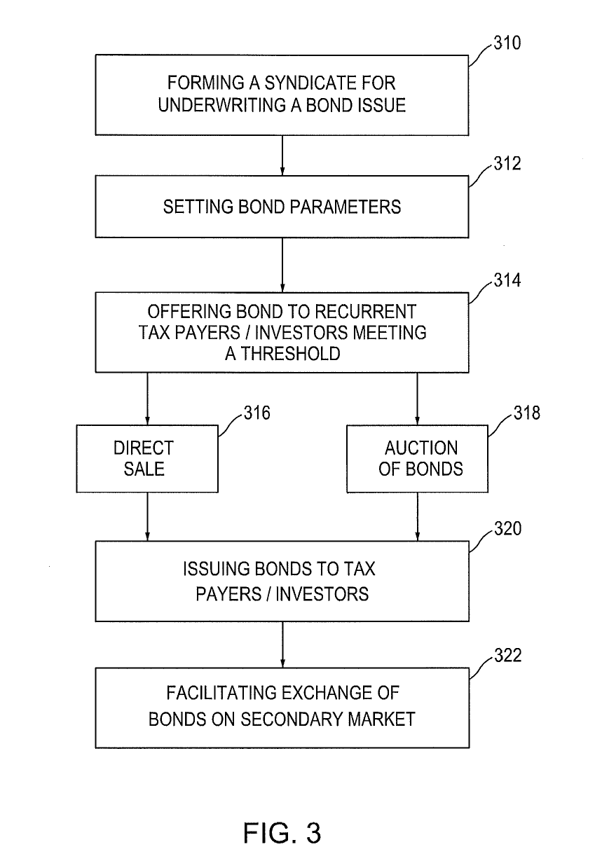

As shown in FIG. 3, the method generally begins with the formation of a syndicate for underwriting a bond issue, at step 310. The formation of a syndicate typically involves one or more banks or securities firms buying an entire issue of bonds from an issuer (e.g., the municipality) for re-sale to investors. The syndicate takes the risk of selling the bonds. The bond parameters are then set, at step 312. This involves setting, for example, the issue price (the price at which the bond will be resold), term (how long until the bond can be redeemed), face amount (the amount to be paid at the end of the term), maturity date (the date on which the issuer has to repay the face amount), and/or coupon (the interest rate that the issuer pay to the bond holders). Of course, other bond parameters may also be set at step 312. The bonds are then offered to recurrent taxpayers who meet a predetermined threshold, at step 314. The threshold is typically set so that only high paying tax payers find it economical to purchase the bonds.

The bonds are then sold to the investors by either a direct sale, at step 316, or by an auction of bonds, at step 318. In a direct sale, the bond is sold at a set price to the investors. In an auction, the bond is sold to the highest bidder. The investors know the issue price, face amount, and maturity date of the bond, and can thus bid accordingly. The bonds are issued to the inventor/tax payers, at step 320. After issuance, the facilitation of the exchange of bonds on secondary markets can then be effectuated, at step 322, in known manners.

For any payment date, whether it is a payment of interest or principal, there may be an election made which results in the bondholder receiving an offset of taxes instead of cash or other value. Although generally referred to as a tax offset, this offset could be against income taxes, property taxes, sales taxes, or any other payment owed to the issuing entity including but not limited to fines and assessments.

The ability to sell bonds is an important feature, especially in instances where the bond owner can no longer use the tax credit. For example, if the bond owner moves out of the municipality where the tax credit can be used (city, town county, state, etc.), the bond owner will most likely want to sell the bond to someone who can take advantage of the tax credit. The purchaser of the bond, assuming they live in the municipality, will be able to use the tax credit when the bond matures.

### Municipal Bonds

In a broad sense, municipal bonds are securities that can be issued for the purposes of financing infrastructure needs of the issuing municipality. These needs very greatly, but can include, for example, roads, streets and highways, schools, bridges, hospitals, public housing, sewer and water systems, power systems, power utilities, and various public projects. The present disclosed system and method, however, is not limited to these purposes and the municipal bonds as used herein can be used for general government purposes, for example. Essentially, through the purchase of a municipal bond the investor is lending money to the issuer (i.e., the government) who promises to repay to the investor the principal plus a fixed or variable amount of interest. Municipal bonds are guaranteed by the government agency of issue.

The municipal issuer that issues the municipal bonds, such as states, cities, and counties, for instance, typically does so to raise funds for public interest projects for which they do not have immediate funds at their disposal. Bonds bear an interest either at fixed or a variable rate and can be subject to either or both a minimum or maximum coupon rate.

A bond measure is an initiative to sell bonds for the purpose of acquiring funds for various public works projects, such as, for example, research, transportation infrastructure improvements, and others. These measures are put up for a vote in general elections and must be approved by a plurality or majority of voters, depending on the specific project in question. Such measures are very often used in the United States when other revenue sources, such as taxes, are limited or non-existent.

A municipal bond is essentially a way of issuing debt. The methods and traces of issuing debt are governed by an extensive system of laws and regulations, which vary by state. Bonds bear interest at either a fixed or variable rate of interest, which can be subject to a cap known as the maximum legal limit. If a bond measure is proposed in a local county election, a Tax Rate Statement may be provided to voters, detailing best estimates of the tax rate required to levy and fund the bond.

The municipal issuer of the bond receives a cash payment at the time of issuance in exchange for a promise to repay the investor(s) who provide the cash payment over time. These individuals are called bondholders. Repayment periods can be as short as a few months (although this is rare) to 20, 30, or 40 years, or even longer. The present inventor knows of no municipal bond where an election can be made such that the bondholder will receive a credit against his/her taxes in lieu of receiving cash payment or other value for interest or principal payments due him/her. The tax liability can take the form of any taxes levied by the issuing municipality.

Repayment periods for bonds can be as short as a few months, but are often measured in years, decades, or even centuries. The uses of the bonds are not relevant to the present TOMS system, but bonds are usually used for capital projects, public interest projects, or for purposes for which a government cannot or does not desire to pay for immediately with the funds on hand.

Given the economic crisis caused by recessions and/or other relatively short term problems, however, governments are motivated to increase revenue. Typically, such revenue increases are achieved through increasing tax rates, which is very unpopular and frowned upon, especially in times of recession. Bonds can be issued as an alternative to tax increases, but tax regulations may limit the use of municipal bonds or require that the money raised by a bond to be spent on one time capital projects or other public interest projects within anywhere from 3-5 years, for example. However, even if these limitations are imposed, the present system and method permits municipal bonds to be issued on a more economical basis than would otherwise be the case. Additionally, there are exceptions to the limited purposes regarding the issuance of bonds to fund other items including, for example, ongoing operations and maintenance expenses, the purchase of single-family and multi-family mortgages, and the funding of student loans, among many other things.

Municipal bonds are generally a highly sought after investment because of their tax-exempt status. Income generated from the purchase of a municipal bond may be exempt from federal, state or local income taxes, depending on the intent of the bond. For instance, bonds issued for projects intended for the common good (i.e., municipal bonds) are generally classified as tax exempt. Bonds that fund projects for the benefit of private parties are not classified as tax exempt (e.g., offering bonds to support a company coming into the area). Typically, an investor usually receives a lower interest rate payment on municipal bonds than other private bonds because of their special tax exempt status (assuming comparable risk). This makes the issuance of bonds an attractive source of financing to many municipal entities, as the borrowing rate available in the open market is frequently lower than what is available through other borrowing channels. The present system and method lowers the credit risk of investing in municipal bonds by giving bondholders a way to realize value in the event the event a municipality is unable pay.

Municipal bonds are one of several ways states, cities and counties can issue debt. Other mechanisms include certificates of participation and lease-buyback agreements. While these methods of borrowing differ in legal structure, they are similar to the municipal bonds described in this disclosure.

Municipal bondholders may purchase bonds either directly from the issuer at the time of issuance (on the primary market), or from other bond holders at some time after issuance (on the secondary market). In exchange for an upfront investment of capital, the bond holder receives payments over time composed of interest on the invested principal, and a return of the invested principal itself.

Repayment schedules differ with the type of bond issued. Municipal bonds typically pay interest semi-annually. Shorter term bonds generally pay interest only until maturity. Longer term bonds generally are amortized through annual principal payments. Longer and shorter term bonds are often combined together in a single issue that requires the issuer to make approximately level annual payments of interest and principal. Certain bonds, known as zero coupon or capital appreciation bonds, accrue interest until maturity, at which time both interest and principal become due.

### Types of Tax-Exempt Bonds

Municipal bonds are highly sought after as they provide tax exemption from federal taxes and many state and local taxes, depending on the laws of each state. Purchasers of municipal bonds should be aware, however, that not all municipal bonds are tax-exempt. Bonds are typically certified by a law firm as either tax-exempt (federal and/or state income tax) or taxable before they are offered to the market. It will be understood that the disclosed method and apparatus applies equally to both tax-exempt and taxable bonds.

One of the primary reasons municipal bonds are considered separately from other types of bonds is their special ability to provide tax-exempt income. Interest paid by the issuer to bond holders is often exempt from all federal taxes, as well as state or local taxes depending on the state in which the issuer is located, subject to certain restrictions. Bonds issued for certain purposes are subject to the alternative minimum tax.

The type of project or projects that are funded by a bond affects the taxability of income received on the bonds held by bond holders. Interest earnings on bonds that fund projects that are constructed for the public good are generally exempt from federal income tax, while interest earnings on bonds issued to fund projects partly or wholly benefiting only private parties, sometimes referred to as private activity bonds, may be subject to federal income tax. However, qualified private activity bonds, whether issued by a governmental unit or private entity, are exempt from federal taxes because the bonds are financing services or facilities that, while meeting the private activity tests, are needed by a government.

Municipal securities consist of both short term issues (often called notes, which typically mature in one year or less) and long term issues (commonly known as bonds, which mature after more than one year). Short term notes are typically used by an issuer to raise money for a variety of reasons: for example, in anticipation of future revenues such as taxes, state or federal aid payments, and future bond issuances; to cover irregular cash flows; meet unanticipated deficits; and/or raise immediate capital for projects until long term financing can be arranged. Bonds are usually sold to finance capital or public interest projects over the longer term.

The risk (“security”) of a municipal bond is a measure of how likely the issuer is to make all payments, on time and in full, as promised in the agreement between the issuer and bond holder (the “bond documents”). Different types of bonds are secured by various types of repayment sources, based on the promises made in the bond documents.

The basic types of municipal bonds are:

(1) General obligation bonds—Principal and interest are secured by the full faith and credit of the issuer and usually supported by either the issuer's unlimited or limited taxing power. The issuer promises to repay the principal and interest in full faith. In many cases, general obligation bonds are voter approved and are the more secure of the municipal bonds. They generally have low interest rates.

(2) Revenue bonds—Principal and interest are secured by revenues derived from tolls, charges, water utility payments by customers or rents from the facility built with the proceeds of the bond issue. Public projects financed by revenue bonds include, for example, toll roads, bridges, airports, water and sewage treatment facilities, hospitals and subsidized housing. Many of these bonds are issued by special authorities created for that particular purpose.

(3) Assessment bonds—Repayment depends on the income received from property tax assessments on properties located within the issuer's boundaries.

In addition, there are several other types of municipal bonds with different promises of security. Most municipal notes and bonds are issued in minimum denominations of $5,000, or multiples of $5,000.

The probability of repayment, as promised, is often determined by an independent reviewer, or “rating agency.” The three main rating agencies for municipal bonds in the United States are Standard & Poor's, Moody's, and Fitch. These agencies can be hired by the issuer to assign a bond rating, which is valuable information to potential bond holders that helps sell bonds on the primary market. To alleviate some of the risk, bond insurance may be purchased. Bond insurance is a type of insurance wherein an insurance company guarantees the scheduled payments of interest and principal on a bond, or other security, in the event of a payment default by the issuer of the bond or security. The insurance company is paid a premium (either as a lump sum or in installments) by the issuer or owner of the security to be insured. Bond insurance is a form of “credit enhancement” that generally results in the rating of the insured security being the higher of: (i) the claims-paying rating of the insurer; and (ii) the rating the bond would have absent insurance (which is also known as the “underlying” or “shadow” rating).

The premium requested for insurance on a bond is typically a measure of the perceived risk of failure of the issuer. The more financially secure the issuer, the less the premium. It can also be a function of the interest savings realized by an issuer from employing bond insurance or the increased value of the security realized by an owner who purchased bond insurance. In one form, the disclosed system and method can be viewed as a substitute to bond insurance. The owner of the bond may have the option to receive the payments or to take the tax credits. In the event that the municipality is unable to pay, the owner of the bond can elect to take the tax credit. The owner would receive a tax credit in the amount he/she would have been paid, and thus still receive the same economic value.

In still another form, the bond could be backed by a different taxing body. For example, say a county issued a municipal bond. The bond could be backed by the state. Should the county be unable to make payments on the bond, the owner of the bond could take the credit against his/her state taxes instead. This would again function as a substitute for bond insurance where the bond owner receives the same economic value regardless of the bond issuer's ability to pay.

The disclosed system and method can also be implemented through netting agreements such as those seen in interest-rate swaps. For example, consider a TOMS private placement negotiated between a single purchaser and the issuer. In this example, the issuer is a local municipality, and the purchaser is a company that pays substantial property taxes to that municipality. The terms of the note include a netting provision where the company nets its tax payment to the county against what is owed to it under the note (the interest payment dates and tax dates even coincide). Provided the company's tax liability is certain to equal or exceed the value of payments due under the bond, the investing company is assured of receiving full value from the bond even if the municipality is unable to make payment.

Municipal bonds have traditionally had very low rates of default as they are backed either by revenue from public utilities (revenue bonds), or state and local government power to tax (general obligation bonds). Give the strong backing of municipal bonds, it is unlikely that the municipality will go into bankruptcy or otherwise be unable to make the payments. However, sharp drops in property valuations resulting from the 2009 mortgage crisis have led to strained state and local finances, potentially leading to municipal defaults. For example, when faced with falling revenues, Harrisburg, Pa. skipped several bond payments on a municipal waste to energy incinerator and did not budget more than $68-million for obligations related to this public utility. The prospect of Chapter 9 municipal bankruptcy was raised by the Controller of Harrisburg, although it was opposed by Harrisburg's mayor.

Key information about new issues of municipal bonds (including, among other things, the security pledged for repayment of the bonds, the terms of payment of interest and principal of the bonds, the tax-exempt status of the bonds, and material financial and operating information about the issuer of the bonds) typically is found in the issuer's Official Statement. Official Statements generally are available at no charge from the Electronic Municipal Market Access system (“EMMA”) via its website at http://emma.msrb.org operated by the Municipal Securities Rulemaking Board (“MSRB”). For most municipal bonds issued in recent years, the issuer is also obligated to provide continuing disclosure to the marketplace, including providing annual financial information and notices of the occurrence of certain material events (including notices of defaults, rating downgrades, events of taxability, etc.). Continuing disclosures also are available for free from the EMMA continuing disclosure service.

### Issuing Bonds

Bonds are typically issued by public authorities, credit institutions, companies and supranational institutions in the primary markets. The most common process of issuing bonds is through underwriting. In underwriting, one or more securities firms or banks, forming a syndicate, buy an entire issue of bonds from an issuer (e.g., a municipality) and re-sell them to investors. The securities firm takes the risk of being unable to sell the issued bonds to end investors. Primary issuance is arranged by bookrunners who arrange the bond issue, have the direct contact with investors, and act as advisors to the bond issuer in terms of timing and price of the bond issue. The bookrunners' willingness to underwrite must be discussed prior to opening books on a bond issue, as there may be limited appetite to do so given a particular bond issue.

In the case of government bonds, these are usually issued by auctions, called a public sale, where both members of the public and banks may bid for bond. Since the coupon is fixed, but the price is not, the percent return is a function of both the price paid as well as the coupon. However, because the cost of issuance for a publicly auctioned bond can be cost prohibitive for a smaller loan, it is also common for smaller bonds to avoid the underwriting and auction process through the use of a private placement bond. In the case of a private placement bond, the bond is held by the lender and does not enter the large bond market.

It will be understood that tax offsets may be offered by an entity other than the issuer. For example, a state may offer tax offsets against state income taxes for a bond issued by a county municipality. This enables a bondholder to obtain a tax credit at the state level via the purchase of a local municipal bond.

### Features of Bonds

The most important features of a bond are:

Nominal, principal or face amount—the amount on which the issuer pays interest, and which, most commonly, has to be repaid at the end of the term. Some structured bonds can have a redemption amount which is different from the face amount and can be linked to performance of particular assets, such as, for example, a stock or commodity index, a foreign exchange rate, or a fund. This can result in an investor receiving less or more than his original investment at maturity.

Issue price—the price at which investors buy the bonds when they are first issued, which will typically be less than the nominal amount. At an auction, the issue price can vary. The net proceeds that the issuer receives are thus the issue price, less issuance fees/expenses.

Maturity date—the date on which the issuer has to repay the nominal amount. As long as all payments have been made as of the maturity date, the issuer has no more obligation to the bond holders after the maturity date. The length of time until the maturity date is often referred to as the term, or tenor, or maturity of a bond. The maturity can be any length of time. Debt securities with a term of less than one year are, however, generally designated as money market instruments rather than bonds. Most bonds have a term of up to thirty years. However, some bonds have been issued with maturities of up to one hundred years, and some even do not mature at all. In early 2005, a market developed in Euros for bonds with a maturity of fifty years. See http://www.ft.com/cms/s/0/c7204f04-9022-11d9-9a51-00000e2511c8.html#axzz1KB8kA8zg.

Coupon—the interest rate that the issuer pays to the bond holders. Generally, this rate is fixed throughout the life of the bond. However, for less secure bonds, it can also vary with a money market index, such as, for example, LIBOR, or it can be even more exotic. The name “coupon” originates from the fact that in the past, physical bonds were issued which had coupons attached to them. On the coupon dates, the bond holder would give the coupon to a bank in exchange for the payment of the principal and interest (e.g., face amount).

In the market for U.S. Treasury securities, there are generally three groups of bond maturities:

(1) Short Term (bills): have maturities of between one to five years (instruments with maturities less than one year are typically called Money Market Instruments);

(2) Medium Term (notes): have maturities of between six to twelve years;

(3) Long Term (bonds): have maturities greater than twelve years.

Under the TOMS structure, if a bond issuer misses an interest or principal payment, a bondholder realizes value by receiving a tax credit equal to the amount of the missed payment. A security which incorporates this tax offset mechanism could be designed in any number of ways, but one example is outlined below.

### Debt Payment Exchangeable for Tax Credit

The tax credits underlying a TOMS bond would be issued to the Trustee on behalf of the bondholders at the close of the offering. The credits themselves would expire when the matching interest or principal payment was paid, or if payment were not made, at another date as specified in the indenture. A holder could elect to exchange a bond for the matching credits at any time. (The offset mechanism can be implemented either as debt payments exchangeable for tax credits or as tax credits exchangeable for debt payments. A TOMS offering paid in tax credits—but where the holder could exchange each individual tax credit for a matching debt payment—effectively allows a holder to specify cash payment of interest and principal until such payment could not be made or appeared unlikely.)

In any event, the disclosed method and apparatus contemplates a mechanism to insure that if a bondholder receives a tax credit, he or she surrenders the right to receive the matching debt payment. In other words, the tax credits are in lieu of payments.

It will be appreciated that one or more exemplary embodiments of the present invention can provide one or more advantages or none at all. For example, improved the bond issuance and redemption can of the underlying bond transaction can be provided by leveraging conventional authorization processes. Techniques of one or more embodiments of the present system can allow verifying that the bond offer is able to be used for a given purchase at a given time, including steps such as determining if the offer is valid. The system can employ hardware and/or software aspects. Software includes but is not limited to firmware, resident software, microcode, etc., that has been compiled to program a general purpose computer to be a specific purpose computer, or run a specific purpose computer. Software might be employed, for example, in connection with one or more of terminals of the a prospective taxpayer/investor device 110, a secondary market investor device 112, a municipality authority device 114, a tender, or bond agent, device 116, and an index reporting device 118, all connected with each other through a communications network 120. Different method steps can be performed by different processors. The database memory could be distributed or local and the processors could be distributed or singular. The memory devices could be implemented as an electrical, magnetic or optical memory, or any combination of these or other types of storage devices (including memory portions as described above with respect to cards. It should be noted that if distributed processors are employed, each distributed processor that makes up a processor carrying out a function or step generally contains its own addressable memory space. It should also be noted that some or all of computer systems can be incorporated into an application-specific or general-use integrated circuit. For example, one or more method steps could be implemented in hardware in an ASIC rather than using firmware. Displays used in conjunction with each of the entities and processors are representative of a variety of possible input/output devices.

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards). Any tangible medium known or developed that can store information suitable for use with a computer system may be used. The computer-readable code means is any mechanism for allowing a computer to read instructions and data, such as magnetic variations on a magnetic media or optical characteristic variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability a prospective taxpayer/investor device 110, a secondary market investor device 112, a municipality authority device 114, a tender, or bond agent, device 116, and an index reporting device 118, all connected with each other through a communications network 120 or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor.

By way of example, a terminal apparatus associated with each of a prospective taxpayer/investor device 110, a secondary market investor device 112, a municipality authority device 114, a tender, or bond agent, device 116, and an index reporting device 118, all connected with each other through a communications network 120 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe). By way of yet a further example, an active file manager apparatus for processing an active file in a payment system, could include a memory, and at least one processor coupled to the memory. The processor can be operative to perform one or more method steps described herein, or otherwise facilitate their performance.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

While the present invention has been particularly described with reference to exemplary embodiments thereof, it will be understood by those skilled in the art that various modifications and alterations may be made without departing from the spirit and scope of the invention. Accordingly, the disclosed embodiments of the invention are considered merely illustrative, and the invention is limited in scope only as specified in the appended claims.

What is claimed is:

1. A method of issuing municipal and other bonds, comprising the steps of:
issuing, from a bond agent computer, a bond offering for prospective bondholders; and
purchasing, by at least one of the prospective bondholders using a prospective bondholder/investor device, at least one of the offered bonds, wherein at least one purchased bond incorporates the functionality to offset a bond owner's tax liability to a municipality or other tax-imposing authority, this offset in lieu of the bondholder receiving cash payment or other value for interest or principal payments due him.

2. The method of claim 1, wherein the bond offering includes interest payments to be made periodically, and/or at maturity.

3. The method of claim 2, wherein the interest payment is either taxable or tax exempt.

4. The method of claim 1, wherein the bond issuer is one of a state, city, county, any other entity authorized to issue tax-exempt bonds, and any other entity where a tax-imposing authority has agreed to offer the entity's bondholders a tax offset as described herein.

5. The method of claim 1, wherein the prospective investors to whom the bond is offered either personally meet a minimum threshold in terms of tax payments to the entity offering the tax offsets or, if they do not, believe there are others who do and who would themselves be prospective purchasers in the secondary market.

6. The method of claim 1, wherein the bonds are purchased by the prospective bondholders by direct sale at a fixed price or at an auction.

7. A method of issuing municipal and other bonds, comprising the steps of:
issuing, from a bond agent computer, a bond offering for prospective bondholders, the bond offering including a plurality of bonds each having a face value and a maturity date;
purchasing, by at least one of the prospective bondholders using a prospective bond holders/investor device, at least one of the offered bonds,
wherein at least one purchased bond incorporates the TOMS functionality, so that an election can be made such that a bondholder receives a credit against his taxes in lieu of being paid cash or other value for his interest or principal payment.

8. The method of claim 7, wherein the difference between the face value of the bond and a purchase price of the bond is tax exempt, for those issues which are tax exempt.

9. The method of claim 7, wherein the bond issuer is one of a state, city, county, any other entity authorized to issue tax-exempt bonds, and any other entity where a tax-imposing authority has agreed to offer the entity's bondholders a tax offset as described herein.

10. The method of claim 7, wherein the prospective investors to whom the bond is offered either personally meet a minimum threshold in terms of tax payments to the entity offering the tax offsets or, if they do not, believe there are others who do and who would themselves be prospective purchasers in the secondary market.

11. The method of claim 7, wherein the bonds are purchased by the prospective bond holders by direct sale at a fixed price or at an auction.

12. The method of claim 7, wherein the purchased bonds are resold on a secondary market.

13. A system for offering municipal and other bonds comprising:
a bond agent computing device issuing a bond offering for prospective bond holders via a communication network; and
a prospective bondholder computing device connected to the communication network and usable by a prospective bondholder for purchasing at least one of the offered bonds,
wherein the at least one purchased bond incorporates the TOMS functionality, so that an election can be made such that a bondholder receives a credit against his taxes in lieu of being paid cash or other value for his interest or principal payment.

14. The system of claim 13, wherein the bond offering includes interest payments to be made periodically, and/or at maturity.

15. The system of claim 14, wherein the interest payment is taxable or tax exempt.

16. The system of claim 13, wherein the bond issuer is one of a state, city, county, any other entity authorized to issue tax-exempt bonds, and any other entity where a tax-imposing authority has agreed to offer the entity's bondholders a tax offset as described herein.

17. The system of claim 13, wherein the prospective investors to whom the bond is offered either personally meet a minimum threshold in terms of tax payments to the entity offering the tax offsets or, if they do not, believe there are others who do and who would themselves be prospective purchasers in the secondary market.

18. A system for offering municipal and other bonds comprising:
a bond agent computing device issuing a bond offering for prospective bond holders via a communication network, the bond offering including a plurality of bonds each having a face value and a maturity date;
a prospective bondholder computing device connecting to the communication network and usable by a prospective bondholder for purchasing at least one of the offered bonds,
wherein the at least one purchased bond incorporates the TOMS functionality, so that an election can be made such that a bondholder receives a credit against his taxes in lieu of being paid cash or other value for his interest or principal payment.

19. The system of claim 18, wherein the difference between the face value of the bond and a purchase price of the bond is tax exempt, for those issues which are tax exempt.

20. The system of claim 18, wherein the bond issuer is one of a state, city, county, any other entity authorized to issue tax-exempt bonds, and any other entity where a tax-imposing authority has agreed to offer the entity's bondholders a tax offset as described herein.

21. The method of claim 18, wherein the prospective investors to whom the bond is offered either personally meet a minimum threshold in terms of tax payments to the entity offering the tax offsets or, if they do not, believe there are others who do and who would themselves be prospective purchasers in the secondary market.

22. A method of issuing municipal and other bonds, comprising the steps of:
issuing, from a bond agent computer, a bond offering for prospective bondholders; and
purchasing, by at least one of the prospective bondholders using a prospective bondholder/investor device, at least one of the offered bonds, wherein at least one purchased bond incorporates the functionality to offset a bond owner's tax liability to any municipality or other tax imposing authority, this offset in lieu of the bondholder receiving cash payment or other value for interest or principal payments due him.

23. The method of claim 22, wherein the bond offering includes interest payments to be made periodically and/or at maturity.

24. The method of claim 23, wherein the interest payment is either taxable or tax exempt.

25. The method of claim 22, wherein the bond issuer is one of a state, city, county, any other entity authorized to issue tax-exempt bonds, and any other entity where a tax-imposing authority has agreed to offer the entity's bondholders a tax offset as described herein.

26. The method of claim 22, wherein the prospective investors to whom the bond is offered either personally meet a minimum threshold in terms of tax payments to the entity offering the tax offsets or, if they do not, believe there are others who do and who would themselves be prospective purchasers in the secondary market.

27. The method of claim 22, wherein the bonds are purchased by the prospective bondholders by direct sale at a fixed price or at an auction.

28. A method of issuing municipal and other bonds, comprising the steps of:
issuing, from a bond agent computer, a bond offering for prospective bondholders, the bond offering including a plurality of bonds each having a face value and a maturity date;
purchasing, by at least one of the prospective bondholders using a prospective bond holders/investor device, at least one of the offered bonds,
wherein at least one purchased bond incorporates the TOMS functionality, so that an election can be made such that a bondholder receives a credit against his taxes in lieu of being paid cash or other value for his interest or principal payment.

29. The method of claim 28, wherein the difference between the face value of the bond and a purchase price of the bond is tax exempt, for those issues which are tax exempt.

30. The method of claim 28, wherein the bond issuer is one of a state, city, county, any other entity authorized to issue tax-exempt bonds, and any other entity where a tax-imposing authority has agreed to offer the entity's bondholders a tax offset as described herein.

31. The method of claim 28, wherein the prospective investors to whom the bond is offered either personally meet a minimum threshold in terms of tax payments to the entity offering the tax offsets or, if they do not, believe there are others who do and who would themselves be prospective purchasers in the secondary market.

32. The method of claim 28, wherein the bonds are purchased by the prospective bond holders by direct sale at a fixed price or at an auction.

33. The method of claim 28, wherein the purchased bonds are resold on a secondary market.

34. A system for offering municipal and other bonds comprising:
a bond agent computing device issuing a bond offering for prospective bond holders via a communication network; and
a prospective bond holder computing device connected to the communication network and usable by a prospective bondholder for purchasing at least one of the offered bonds,
wherein the at least one purchased bond incorporates the TOMS functionality, so that an election can be made such that a bondholder receives a credit against his taxes in lieu of being paid cash or other value for his interest or principal payment.

35. The system of claim 34, wherein the bond offering includes interest payments to be made periodically and/or at maturity.

36. The system of claim 35, wherein the interest payment is either taxable or tax exempt.

37. The system of claim 34, wherein the bond issuer is one of a state, city, county, any other entity authorized to issue tax-exempt bonds, and any other entity where a tax-imposing authority has agreed to offer the entity's bondholders a tax offset as described herein.

38. The system of claim 34, wherein the prospective investors to whom the bond is offered either personally meet a minimum threshold in terms of tax payments to the entity offering the tax offsets or, if they do not, believe there are others who do and who would themselves be prospective purchasers in the secondary market.

39. A system for offering municipal and other bonds comprising:
a bond agent computing device issuing a bond offering for prospective bond holders via a communication network, the bond offering including a plurality of bonds each having a face value and a maturity date;
a prospective bondholder computing device connecting to the communication network and usable by a prospective bond holder for purchasing at least one of the offered bonds,
wherein the at least one purchased bond incorporates the TOMS functionality, so that an election can be made such that a bondholder receives a credit against his taxes in lieu of being paid cash or other value for his interest or principal payment.

40. The system of claim 39, wherein the difference between the face value of the bond and a purchase price of the bond is tax exempt, for those issues which are tax exempt.

41. The system of claim 39, wherein the bond issuer is one of a state, city, county, any other entity authorized to issue tax-exempt bonds, and any other entity where a tax-imposing authority has agreed to offer the entity's bondholders a tax offset as described herein.

42. The method of claim 39, wherein the prospective investors to whom the bond is offered either personally meet a minimum threshold in terms of tax payments to the entity offering the tax offsets or, if they do not, believe there are others who do and who would themselves be prospective purchasers in the secondary market.
